(19) United States
(12) Patent Application Publication
(10) Pub. No.: US 2005/0097448 A1
(43) Pub. Date: May 5, 2005

(54) Flexible layout when flowing XSL-FO content into PPML copy holes

(75) Inventors: Fabio Giannetti, Bristol (GB); Roger Brian Gimson, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/842,557

(22) Filed: May 11, 2004

(30) Foreign Application Priority Data
Oct. 31, 2003 (GB) 0325473.7

(51) Int. Cl. G06F 15/00

(52) U.S. Cl. 715/508

(57) ABSTRACT

There is disclosed a method and apparatus for laying out at least one document page having at least one variable content copy hole; fitting a variable content into a page; and rendering said page.

### FIELD OF THE INVENTION

The present invention relates to a method and apparatus for rendering a document having a variable content copy hole.

### BACKGROUND TO THE INVENTION

Conventionally, most of the documents printed on a digital printing press comprise artistic works generated by a graphic artist. The graphic artist's job is to convey a message exploiting the stylistic artistic capabilities available in the document creation process. Usually, graphic artists prefer to have very refined control on how the document is laid out, and where the text and/or images are positioned. The graphic artist lays out a document using a set of copy-holes, which are windows into which text is placed.

This model works very well when a document has a static layout and a static content, or if the content is variable, it size is predetermined and does not vary. However, there are situations where content can vary in size within a pre-determined range, and in these circumstances, a traditional static layout is not effective, because the size of the images and/or text appear misplaced or dis-proportionally sized within the copy holes.

Referring to FIGS. 1 to 3 herein, there is shown a simple example relating to internationalization of a document, which illustrates some of the problems.

Referring to FIG. 1 herein, there is illustrated schematically a template 100 for a promotional document having three copy holes 101, 102, 103 which are respectively assigned for containing a fixed logo, for example the logo of a car manufacturer, a variable text, and a fixed image, for example of an image of an automobile.

If the document template is to be suitable for sending to persons in different countries, the same message needs to be conveyed in different languages. Even if special templates are created for Western, Arabic, Japanese, Korean and Chinese languages, then there would still be a large degree of variability in the requirement for space on the document for example, an Italian text may be longer than an English text, and exceed the size constraints of the template.

Referring to FIG. 2 herein, there is illustrated schematically the template, having a fixed logo content, a fixed image content, and a variable text, in this case in the English language applied to the template. In this case, the text fits within the variable text copy hole 102.

Referring to FIG. 3 herein, there is illustrated schematically the same template in which the logo image and fixed image are identical to those as shown in FIG. 2, but the variable text is in Italian. The Italian text takes up a larger space, exceeding the size of the variable text copy hole 102.

Depending upon the language, sometimes the amount of space required by the variable text will exceed the size of the variable text copy hole, and sometimes, the text will fit within the variable size copy hole. The way in which graphic artists deals with this problem at present, is to try and- create a copy hole which is large enough to contain all possible variations of the text. This has the problem of imposing a restriction on the graphic artist's freedom to arrange the layout of the document, and the problem of always needing to take account of the largest possible copy hole size which will be required. The graphic artist cannot take a risk in reducing the size of the variable text copy hole to accommodate an “average” text size, since there may be instances where, depending upon the language, the text may not fit into the variable text copy hole. The graphic artist must select a copy hole, which is large enough to contain the largest size of text, which will be encountered.

Such problems are common in variable data printing (VDP) scenarios. A graphic artist may be facing a problem of creating a unique design for a document to obtain maximum impact with customers, as well as allowing the necessary flexibility to deal with variable content.

### SUMMARY OF THE INVENTION

According to one aspect of the present invention, there is provided a method of processing a document comprising:

creating a plurality of copy holes in a PPML document; and

mapping said PPML copy holes into a plurality of pages of an XSL-FO document.

According to a second aspect of the present invention, there is provided a method of printing data comprising a plurality of individual print items, said method comprising: laying out at least one document page having at least one variable content copy hole;

abstracting a page description language copy hole into a document description language page;

fitting a variable content into a page;

rendering said page; mapping said page to a copy hole formed in a page description language document; and

printing said rendered page within said variable content copy hole.

According to a third aspect of the present invention, there is provided a rendering command extension for extensible style sheet language, said rendering command comprising instructions to a rendering engine for modifying a content such that when said content is modified, it fits within a predetermined area.

According to a fourth aspect of the present invention, there is provided a method of preparing content, said method comprising:

specifying a page within a document defined in a page description language;

assigning an item of content into said page; and

mapping said page to a copy hole formed in a document description language document.

According to a fifth aspect of the present invention, there is provided a method of preparing content for inclusion in a copy-hole, said method comprising:

specifying a page within a document defined in a document description language; and

fitting an item of content into said page; and

mapping said page to a copy-hole formed in a page description language document.

According to a sixth aspect of the present invention, there is provided a method of rendering a document comprising:

inputting a stream of document description language flow as objects;

arranging said objects in a page tree;

applying a sizing algorithm to said objects of said page tree for re-sizing said objects according to instructions contained in said document description language;

predicting whether said content will exceed a corresponding respective area assigned to said object, in a copy-hole defined in a page description language; and

if said prediction determined that said object will exceed said corresponding respective area in said page description language copy-hole, then re-sizing said content object such that when it is rendered, it will fit within said corresponding copy-hole.

According to a seventh aspect of the present invention, there is provided a graphic authoring tool capable of generating a document description language document, wherein, within a page of said document description language document there is specified,

a content item assigned to said page; and

a variable dimension margin.

According to an eighth aspect of the present invention, there is provided a printing system for printing a plurality of individual print items, said printing system comprising:

a component capable of laying out at least one document page having at least one variable content copy hole;

a component capable of fitting a variable content into a page;

a rendering engine capable of rendering said page; and

a printing component capable of printing said rendered page within said variable content copy hole.

According to a ninth aspect of the present invention, there is provided a program code stored on a data carrier, said program code comprising instructions for:

specifying a page within a document defined in a document description language;

fitting an item of content into said page; and

mapping said page to a copy-hole formed in a page description language document.

According to a tenth aspect of the present invention, there is provided a rendering engine for rendering a document, said engine comprising:

a page tree for arranging a stream of document description language flow objects within a tree structure;

a sizing component capable of being applied to said objects of said page tree for re-sizing said objects according to instructions contained in said document description language;

a prediction component for predicting whether said content will exceed a corresponding respective area assigned to said object, in a copy-hole defined in a page description language; wherein

if said prediction component determines that said object will exceed said corresponding respective area in said page description language copy-hole, then said sizing component operates to re-size said content object such that when it is rendered, it will fit within said corresponding copy-hole.

According to an eleventh aspect of the present invention, there is provided a method of processing a document comprising:

creating a plurality of copy holes in a page description language document; and

mapping said copy holes into a plurality of pages of a document description language document.

Other aspects of the invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a document template having copy holes for fixed content and for variable content;

FIG. 2 illustrates schematically the document template of FIG. 1 having a first variable content;

FIG. 3 illustrates schematically the document template of FIG. 1 having a second variable content;

FIG. 4 illustrates schematically a printing system according to a specific embodiment of the present invention;

FIG. 5 illustrates schematically a workflow for processing printed documents in the printing system of FIG. 4;

FIG. 6 illustrates schematically an example of a simple case in which a graphic artist expresses a range of font sizes for content in an XSL-FO page;

FIG. 7 illustrates schematically variation of dimensions of a PPML copy hole in a PPML page;

FIG. 8 illustrates schematically a content window within an XSL-FO document, surrounded by a set of variable size margins;

FIG. 9 illustrates schematically operation of a rendering engine adapted to respond to XSL-FO extension commands for modifying a size of content window within XSL-FO documents according to a second specific embodiment of the present invention;

FIG. 10 illustrates schematically XSL-FO content adaptation by font size reduction for fitting text content into a copy hole;

FIG. 11 illustrates schematically XSL-FO content adaptation by font size enlargement for expanding text content into an available space in a copy hole;

FIG. 12 illustrates schematically XSL-FO content adaptation for dealing with content overflow within a copy hole;

FIG. 13-15 illustrates schematically results of an XSL-FO rendering engine changing font size of a variable content in order to adapt the variable content into a predefined PPML frame work;

FIG. 16 illustrates schematically an example of optimum size copy hole dimensions expressed by a designer;

FIG. 17 illustrates schematically an example of maximum copy hole dimensions expressed by a designer for the same document as shown in FIG. 16;

FIGS. 18-20 illustrate schematically how a graphic artist may decide a precedence and order of expansion for enlarging a copy hole.

FIG. 21 illustrates schematically an example of PPML MARK with an embedded XSL-FO document;

FIG. 22 illustrates schematically adaptation steps carried out by an XSL-FO rendering engine as expected by a graphic artist;

FIG. 23 illustrates schematically collapsible margins in a PPML copy hole, with a relative precedence of collapse between margins;

FIG. 24 illustrates schematically an example of instructions for using a combination of margin size variation and font size variation for fitting variable size text into a copy hole;

FIG. 25 illustrates schematically first to third process in an adaptation process executed by an XSL-FO rendering engine for carrying out the instructions illustrated with reference to FIG. 24; and

FIG. 26 illustrates schematically further fourth and fifth process carried out by the XSL-FO rendering engine for carrying out the process as illustrated with reference to FIG. 24 herein.

### DETAILED DESCRIPTION

There will now be described by way of example a specific mode contemplated by the inventors. In the following description numerous specific details are set fourth in order to provide a thorough understanding. It will be apparent however, to one skilled in the art, that the present invention may be practiced without limitation to these specific details. In other instances, well known methods and structures have not been described in detail so as not to unnecessarily obscure the description.

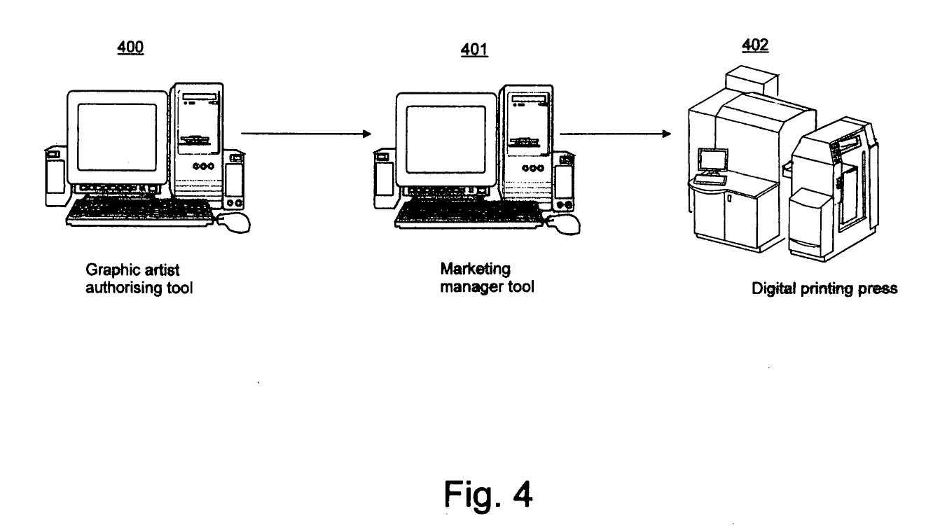

Referring to FIG. 4 herein, there is illustrated schematically a variable data printing system according to a specific embodiment of the present invention. The system comprises: a graphic artist authoring tool 400; a marketing manager tool 401; and a digital printing press 402. The authoring tool 400 may comprise a conventional computer entity configured for running an applications program configured to operate as described herein below. The marketing manager tool 401 comprises a second conventional computer entity, configured to operate according to a marketing manager application which carries out processes as described herein below. The digital printing press 402 may comprise a conventional digital printing press further adapted as described herein below.

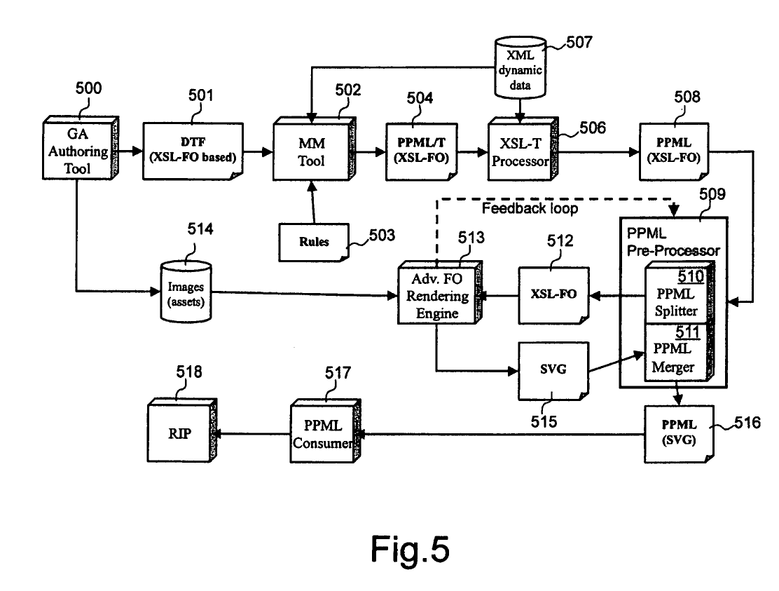

Referring to FIG. 5 herein, there is illustrated schematically a work flow for a variable data printing system as shown in FIG. 4. A graphic artist, uses a graphic authoring tool 500 to produce an XSL-FO (Extensible style sheet language for formatting objects) based document template format (DTF) 501. XSL-FO belongs to a class of languages known as document description languages, DDL, which are languages which describe whole documents, rather than individual pages. In XSL-FO, there is no concept of one page, but there is a concept of a sequence of pages making up a document, and there is also a concept of where the content will be positioned within a page sequence. The document template format 501 is sent to a marketing manager tool 502, which may be an applications program which enables a human operator to apply a set of rules 503 stored in a rules database to the document template format. The marketing manager tool 502 generates a personal print mark-up language templating (PPML/T) output 504, which includes an XSL-FO content flow contained within one or more PPML copy holes. The PPMLFT flow is input into an extensible style sheet language templating (XSL-T) processor 506, which also inputs dynamic extensible mark-up language (XML) data 507 from an XML dynamic database. The PPML (XSL-FO) flow 508 is input into a PPML pre-processor 509 which comprises a PPML splitter 510 and a PPML merger 511. An XSL-FO flow 512 is output from the PPML splitter 510 and is input into an XSL-FO rendering engine 513. Rendering is the process whereby content objects (such as lines of text, for example) are located on a page or sequence of pages to produce a layout for a document which is then suitable for rasterizing. The XSL-FO rendering engine takes a set of images 514 from an image database 514, and generates an SVG output 515 which is fed back into the PPML merger 511 comprising the PPML pre-processor 509. An output of the PPML merger 511 is a PPML (SVG) flow 516 which is input into a PPML consumer 517 to result in a raster image processed output 518.

The use of XSL-FO in conjunction with PPML to create documents is known from our co-pending U.S. application Ser. No. 10/668,958, filed on 24 Sep. 2003, the contents of which are hereby incorporated by reference.

There will now be described in over view, a specific method according to the present invention.

A suitable way to accommodate variable content in a document is to change the style of the document in a way which reduces the space required to render the content inside an allocated copy hole. There are several properties of the content which could be effected to achieve a result.

According to one specific method of the present invention, extensions are made to the XSL-FO language, to allow that language to allocate a variable size to an item of content.

One option is to embed XSL-FO in one of the variable text copy holes where the XSL-FO has extensions. An example of a new extension to the XSL-FO language may be:

< fo : block font-size.optimum = “12 pt”
font-size.minimum = “10 pt”/ >

This extension specifies a range of font sizes within the XSL-FO flow. In other words, the size of the content, in this case text can be set within a pre-determined range of sizes. The rendering engine is modified so as to be capable of understanding the extension, and to render the content with the optimum font size of 12 pt, or if the content is of a volume which exceeds the area of the copy-hole, to render the content with a minimum font size of 10 pt.

Properties of content which may be made variable, by including extension commands within XSL-FO include the following:
text font size
text line spacing
text line width
text line height
image magnification
text block spacing
margin, and/or border size
padding areas between a border and a content item

Consequently, a graphic artist can work with a page in XSL-FO, which contains variable content, which can be rearranged, expanded or contracted within predetermined limits which are user settable.

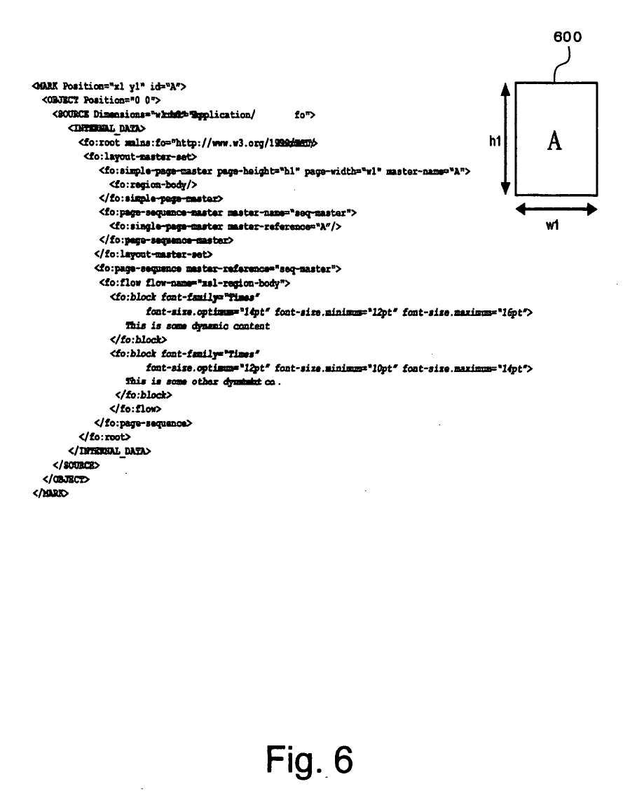

Referring to FIG. 6 herein, in XSL-FO, a window 600 can be formed which is for a single page only. If an amount of content does not fit into the window, then there is a command to truncate the content, so that it fits into the single window.

XSL-FO is extended, according to a specific method herein, such that the content is optimized in size such that it is rendered to fit inside the page 600, within specified upper and lower limits of font size. In the rendering engine, the page content is rendered at the optimum size. If the optimum size rendering results in a page size which exceeds the copy hole size, then the rendering engine can re-render the same content at reduced dimensions, so that the content is reduced in size and fits within the XSL-FO page.

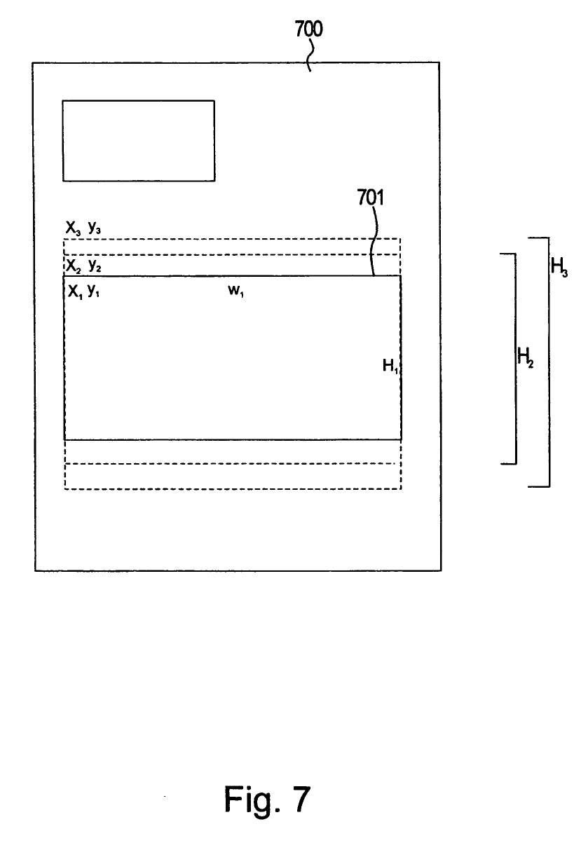

Referring to FIG. 7 herein, there is illustrated schematically a PPML page 700 having a copy hole 701. The copy hole has width W, and height H, a feature of PPML is that if size of a copy hole is adjusted, an aspect ratio of the copy hole does not adjust automatically. Rather, each copy hole is defined by a position X, Y and by a width W, and by a height extending in orthogonal directions away from that X, Y position. Therefore, in order to change the size of the copy hole whilst keeping the copy hole centered within the PPML page at a constant position, the position of the copy hole needs to be moved, as the size of the copy hole changes. For a first width W₁ and first height H₁ at a first position X₁, Y₁, as shown in FIG. 7, to expand the height to a second height H₂ requires a movement of the position of the copy hole to a second position X₂ Y₂. Similarly, for expansion of the copy hole to a third height H₃, this requires repositioning the copy hole to a third position X₃, Y₃Therefore, adjusting the size of the copy hole in order to accommodate variable size text is difficult, especially where there are adjacent copy holes in fixed positions. If there were to be more than one copy hole whose size may expand or contract depending upon the variable content which it contains, then the layout and geography of the PPML page would change to an extent to give a significantly different look and feel to the presentation, and risk collisions between copy holes where they overlap a same region of the PPML page. This would mean that algorithms for re-packing the copy holes or reconfiguring the layout of the copy holes would need to be applied in order to change the layout every time an item of content varied in size. However, in general, graphic artists do not wish to leave the overall layout to a computer program, since the layout of a page on a document involves an element of subjective artistic judgement.

Within current versions of PPML, there is no flexibility for dynamically changing the size of copy holes automatically to accommodate the variable size content.

According to a specific method of the present invention, a graphic artist defines a maximum size of copy hole, for example, corresponding to the copy hole at position X₃, Y₃ having width W₁ and height H₂ as shown in FIG. 7. Then within the maximum sized copy hole, any expansion H₃, contraction or rearranging of text is implemented in XSL-FO by means of extension commands added into the XSL-FO language. Consequently, the copy hole does not need to move relative to the PPML page, so the basic layout and geography of the PPML page is preserved. The position of the copy hole is fixed, as are its height and width.

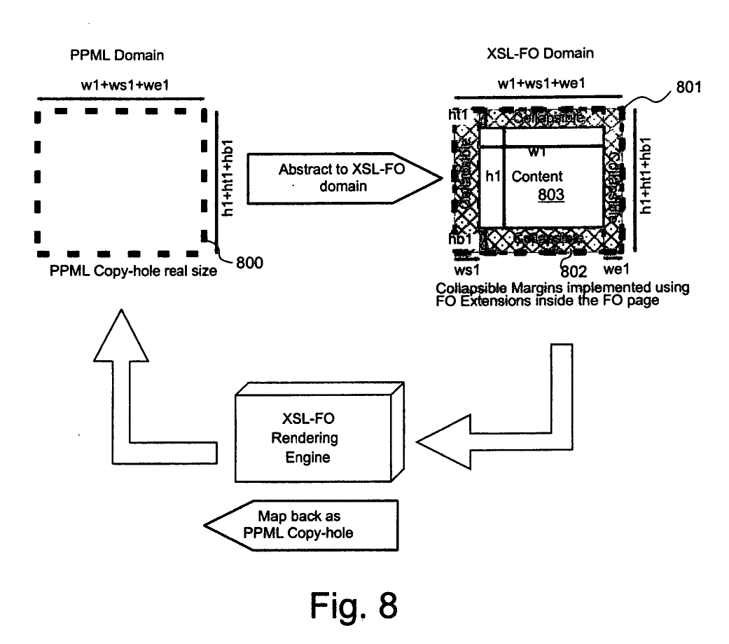

Referring to FIG. 8 herein, there is illustrated schematically extraction of a PPML copy hole 800 of fixed maximum dimension into an XSL-FO page 801. The XSL-FO page is set to have height and width dimensions which coincide with those of the copy hole into which the XSL-FO page is to fit into.

A margin 802 can be created to surround an item of content 803 within the XSL-FO page, the margin may be of variable size so it can be collapsed to zero width and zero height, or expanded. The margin has a left margin width ws1, a right width we1, a lower margin height hb1, and an upper margin height ht1. In a preferred mode of operation, a size of the margin is equally balanced above and below the copy hole, so that as the contents expands or contracts, the content remains positioned substantially centrally within the XSL-FO page. Further, where the size of the content is magnified or shrunk, in one specific method, the left and right margin widths ws1, we1 respectively may be expanded or contracted in parallel, so that the width of the left and right margins remain constant.

However, in other instances, the height ht1 of the upper margin and height hb1 of the lower margin may be expanded or contracted in different proportions to each other and independently of each other.

An extension command to XSL-FO for implementing a 1 cm dimension upper margin may be as follows:

```
< SIMPLE_PAGE_RASTER
    MARGIN.TOP...MAXIMUM = “OPT”
    MARGIN.TOP...OPTIMUM = “1 CM” >
```

This command sets the top margin to be a maximum dimension of a pre-set optimum size “OPT” and sets an optimum size of the margin, in this example, to be 1 cm thick.

Similar commands may exist for left margin, right margin, and lower margin.

In each case, a maximum size of the margin can be set and an optimum size of the margin can be set.

Other commands may be generated of a similar form, which allow a minimum size of the margin to be preset for each of the upper, lower, left and right margins.

The rendering engine is modified to act on the command, so as to render the content to provide a content constrained within the margins set in the XSL-FO page. In this way, if the content expands, the margin can be contracted to allow the space available for the content to expand. The margin can vary between a dimension of zero and a maximum dimension of a preset optimum maximum dimension, with the default margin being set at an optimum value of 1 cm in the example shown. This makes sure that the content can be always placed centrally within the copy hole. Therefore, the basic positioning of content within a PPML page is preserved and the content looks as if it has been properly laid out, since the central position of the content is the same, whatever the size of the content.

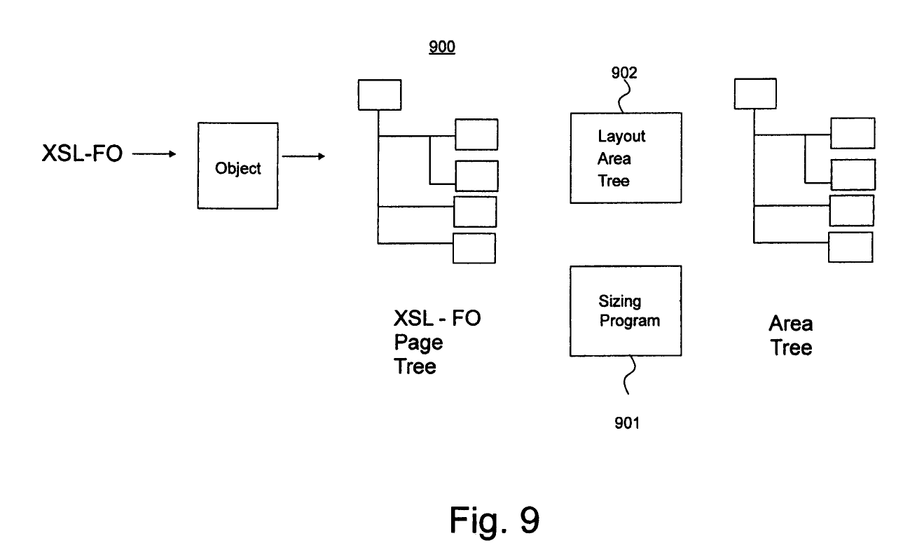

Referring to FIG. 9 herein, there is illustrated schematically a mode of operation of a modified rendering engine according to a specific embodiment of the present invention. The modified rendering engine inputs XSL-FO pages as objects, and arranges them in an XSL-FO page tree 900, in which a sizing program 901 operates on a layout area tree data 902 to resize the content, within the constraints specified in the XSL-FO extension commands. A tree 900 of XSL-FO pages is mapped onto a tree 901 of areas. If the content in the XSL-FO pages is predicted to exceed a corresponding respective area in a PPML document, then the sizing program predicts this, and resizes the XSL-FO content such that when it is rendered, it fits within the corresponding copy hole.

An example of operation may be as follows: Taking for example 4 XSL-FO content objects, each allocated to a separate XSL-FO page, where each XSL-FO object is allocated to a corresponding respective copy hole in a PPML document, the layout area tree maps the XSL-FO content objects to the area tree. The sizing program checks whether any individual content is set to exceed the corresponding available area in the copy hole and if so resizes either an individual object, or all objects, so that the largest XSL-FO object fits within the allocated area. The sizing program does this by collapsing the margin from its default optimum value, to a minimum value, or to an intermediate value between the minimum value and the optimum value.

Conversely, where the XSL-FO content is relatively small and results in a large margin, for example a margin having dimensions which exceeds the maximum margin size, then the sizing programming can magnify the content, expanding it so that the content occupies the central area of the XSL-FO page up to the extent of the maximum allowable margin, in other words, so that it fills the center of the XSL-FO page having the maximum specified margin. Again, the sizing program can expand just one XSL-FO page, or a plurality of XSL-FO pages in parallel.

Applying a Procedure to Changes in Content Style

A suitable way to accommodate the variable content is to change its style in a way to reduce the amount of space required to render it inside the allocated copy-hole. There are several properties that could be effected to achieve the result. A graphic artist may express ranges of values for those parameters as well as a precedence value in a modified graphic artist authoring tool. This last parameter will be used from the adaptation framework to execute the adaptation algorithm following the graphic artists' wishes, so the resulting document will have the expected appearance.

For example some of the properties that could be changed are the font-size, but properties including font-family; font-style; line-spacing; and borders may also be changeable.

This methodology is related to the combination of the PPML (Personalized Printing Markup Language) and XSL-FO (extensible Stylesheet Language-formatting Objects) already described. Using the combination of those two technologies it is possible to achieve a lot of flexibility inside a copy-hole, leaving to the XSL-FO Rendering Engine the task of adapting the content to suit the copy-hole dimensions.

FIG. 6 shows a simple case where the graphic artist has expressed font-size ranges using an XSL-FO extension command based on the already available concept of length range composed by minimum, optimum and maximum.

When the adaptation processor, which could be a PPML Merger, parses this copy-hole it will extract the XSL-FO content and send it to an XSL-FO Rendering Engine responsible for layout of the content, and return a suitable format for the PPML consumer such as SVG or page description language.

The XSL-FO Rendering Engine will now be capable of adapting the content following the graphic artist wishes, trying the optimum solution but also opting for the maximum and minimum when required.

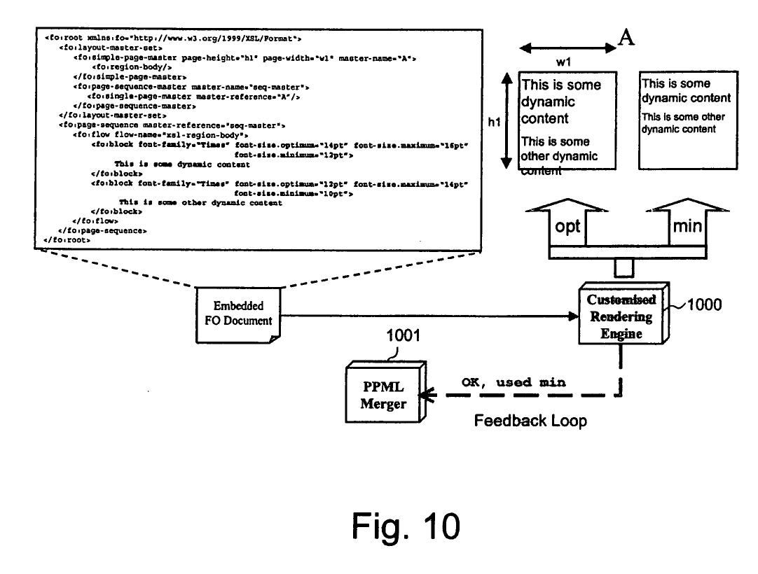

Referring to FIG. 10 herein, there is depicted a simple example of the adaptation process which highlights the feedback loop available between the XSL-FO Rendering Engine 1000 and the PPML Merger 1001.

In the above example the graphic artist has expressed just three values for the font-size, minimum, optimum and maximum. More complicated in formation ranges may also be expressed as well as range decreasing and/or increasing factors. Using these kind of paradigms it can be ensured that the Rendering Engine will have a pre-defined number of actions to take and will not fall in deadlock.

The graphic artist can also express the wish of a maximum value which is greater than the optimum. This is particularly useful when there is a wide amount of variable data between the various document instances. If a particular instance of a variable content is short, this could affect the document appearance, especially for the amount of empty space left in the copy-hole after the rendering.

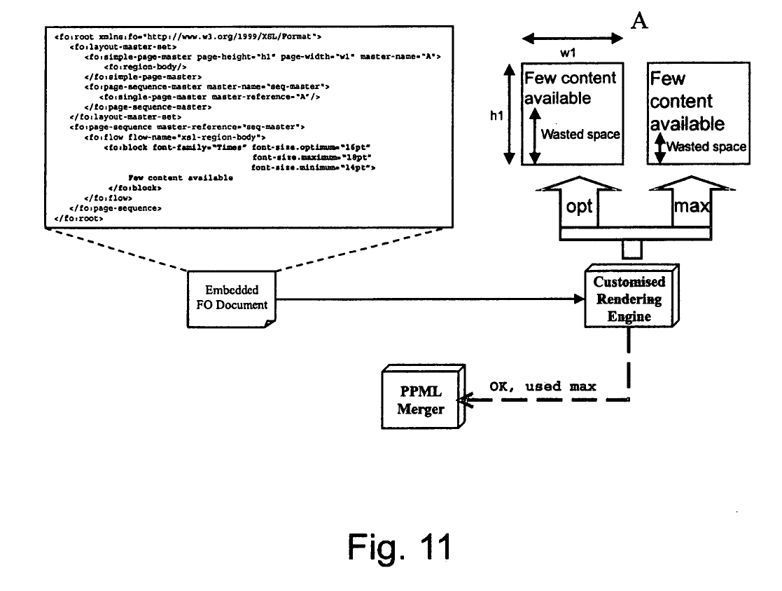

Referring to FIG. 11 herein, there is illustrated schematically an example where the XSL-FO Rendering Engine can opt for the maximum font-size, if this reduces the amount of empty space left according to a pre-defined strategy.

The adaptation workflow will also take advantage of the feedback loop. If the design is broken by an anomalous variable content amount, the XSL-FO Rendering Engine will use the available style flexibility but may find that it is not possible to correctly fulfil the copy-hole.

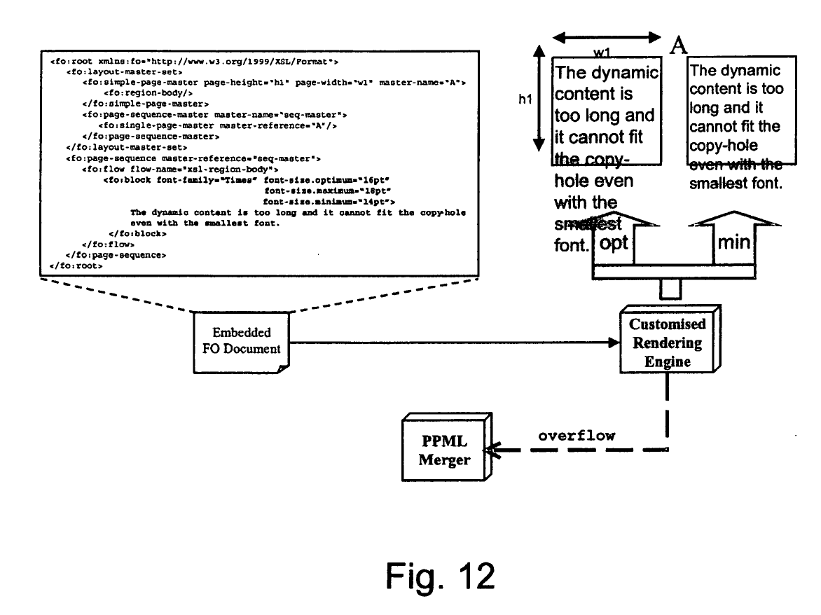

Referring to FIG. 12 herein, this shows a the rendering failure with subsequent notification to the PPML Merger.

When an Overflow situation happens, the PPML Merger will be notified and it can pull the document out of the production workflow raising a warning requiring human assistance to correct the fault. This approach is very useful since it will prevent the possibility of printing erroneous documents.

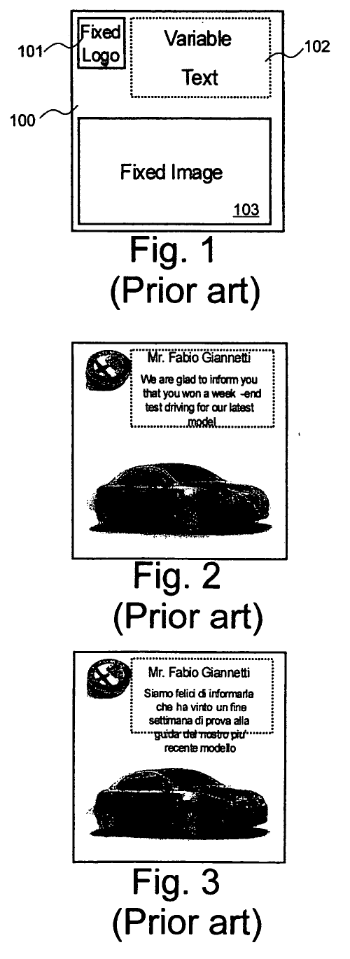

Using this approach it can be seen how the XSL-FO Rendering Engine will change, for instance, the font-size for the example shown in FIG. 1.

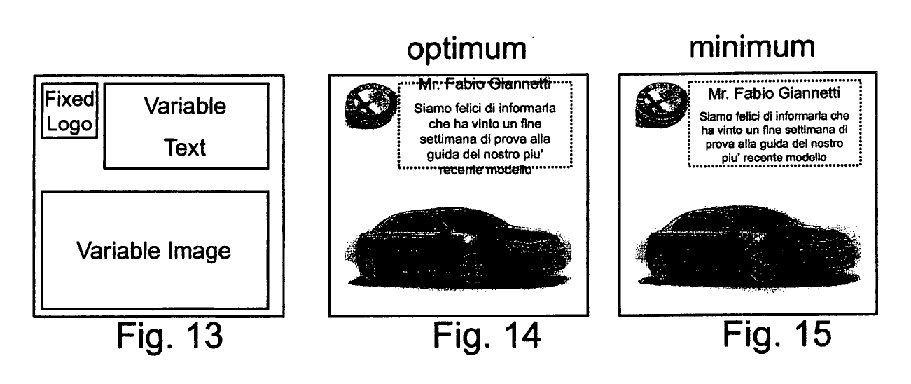

Referring to FIGS. 13 to 15 there is shown the adaptation carried over the XSL-FO Content to fulfil the copy-hole.

Copy-Holes with Flexible Dimensions Using XSL-FO

Another way to achieve variable data fulfillment in a copy-hole is to dynamically re-size it. Since the copy-hole determines the document look and feel, the graphic artist must be in control of the re-size process as well as fixing expansion or contraction values.

Using a similar approach to the styling in formation, the graphic artist may define a range of dimensions for the copy-hole, expressing first of all, the optimum design and subsequently variations to it that could be captured as a minimum and a maximum, or a more complex range.

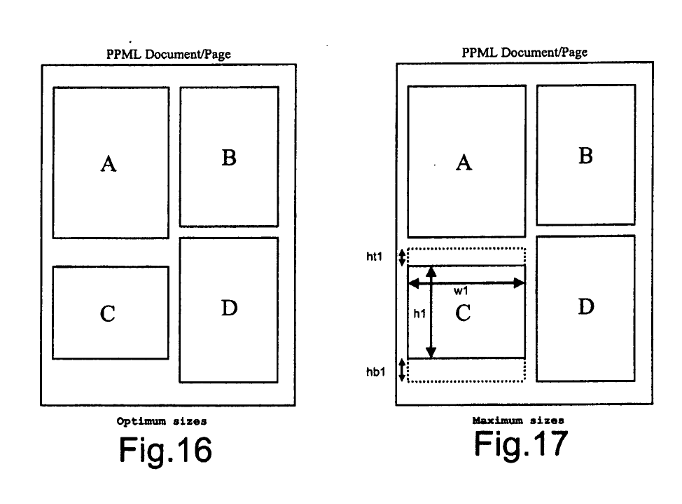

Referring to FIGS. 16 and 17 herein, there is shown a design with optimum and maximum dimension values for a copy-hole expressed by the graphic artist at design time.

The graphic artist has expressed w₁ as the copy-hole's optimum width and h₁ as the copy-hole's optimum height. The graphic artist has subsequently defined a possible copy-hole growth in height both from the top and the bottom borders. Those two expanded sizes have been identified using ht₁ (height top) and hb₁ (height bottom). Next the graphic artist expresses the precedence in which those borders will be enhanced to accommodate the variable data.

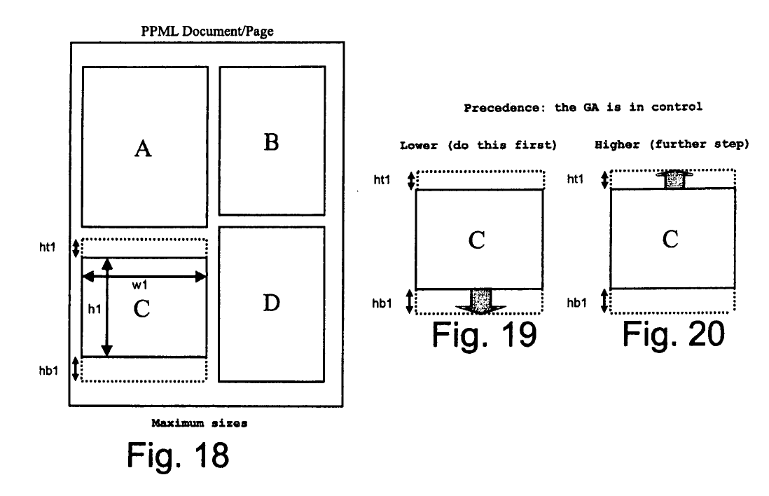

Referring to FIGS. 18 to 20 herein, there is shown a set of precedence values which will dictate the adaptation steps and will force the XSL-FO Rendering Engine to behave as the graphic artist has defined.

To achieve this result the actual copy-hole, which is expressed as a PPML Mark, will have the overall dimension equal to w₁ and h₁+ht₁+hb₁. The copy-hole has de-facto the maximum size, and the contained XSL-FO object will have page margins which will determine the real copy-hole size. At the beginning the XSL-FO page margins are set to ht₁ for the top and hb₁ for the bottom.

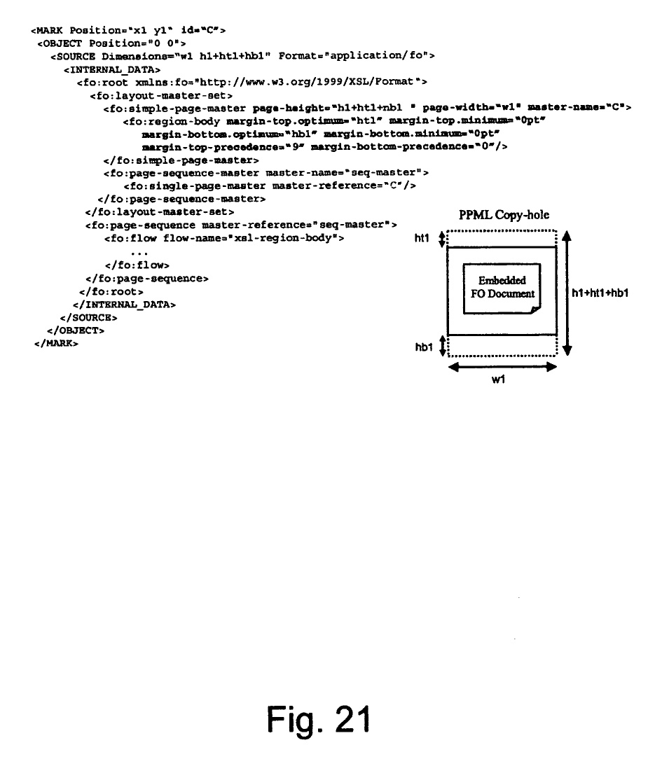

Referring to FIG. 21 here, there is shown the PPML Mark with the embedded XSL-FO document.

The XSL-FO Rendering Engine will collapse the margin-top and margin-bottom accordingly to the variable data content. If is required for the copy-hole enlargement the XSL-FO Rendering Engine will collapse the margins accordingly to the graphic artist preferences, expressed using precedence, until the content will fit.

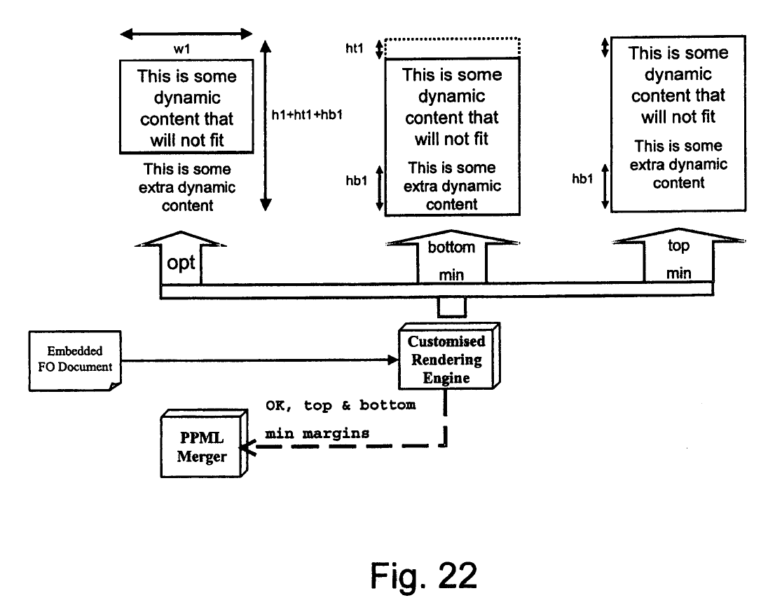

Referring to FIG. 22 herein, there is shown the adaptation steps executed by the XSL-FO Rendering Engine as expected by the graphic artist.

A further advantage in this approach is that the copy-hole will always be automatically centred even if its overall size has changed. This is possible because the PPML Mark is in reality fixed and it has the bigger size, the embedded XSL-FO document is actually modifying the page margins to adjust the appearance. In this way the graphic artist is secure in the knowledge that the adaptation framework will not modify the overall design, since the PPML Marks are laid out once and they will not change position, creating undesirable artefacts such as a misalignment and so on.

The above example shows only the top and bottom margins but, it is possible to define also the left and right margins. Each margin could have different sizes and precedence, and so the copy-hole can grow differently accordingly to the amount of variable data it is required to fulfil. It will be also possible to define the same size for all the four margins and give them the same size so the copy-hole will grow symmetrically and it will be possible, as explained in the previous section, to use ranges of values and range steps to express more than two values.

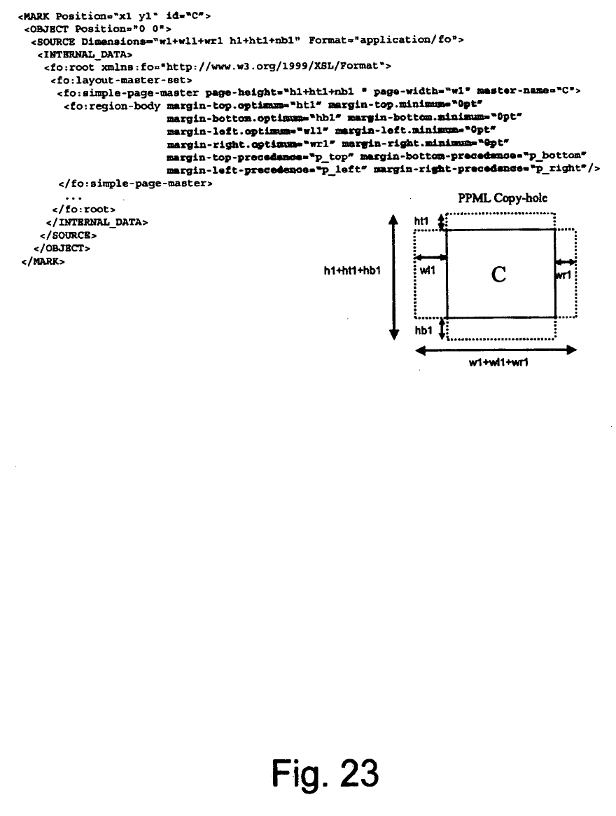

Referring to FIG. 23 herein, there is shown schematically a first possible extension for a case having only three values, for all four copy-hole margins.

Complex Fulfilment Strategies Under the GRAPHIC ARTIST Control

In a further embodiment, the two above described approaches are combined into a single strategy. The graphic artist, using the precedence rules, will be in control of how the XSL-FO Rendering Engine will execute the steps to fulfil the content and he/she may able to specify as many styling attributes or collapsible margin ranges as desired tuning, as well as, the level of granularity between PPML and XSL-FO.

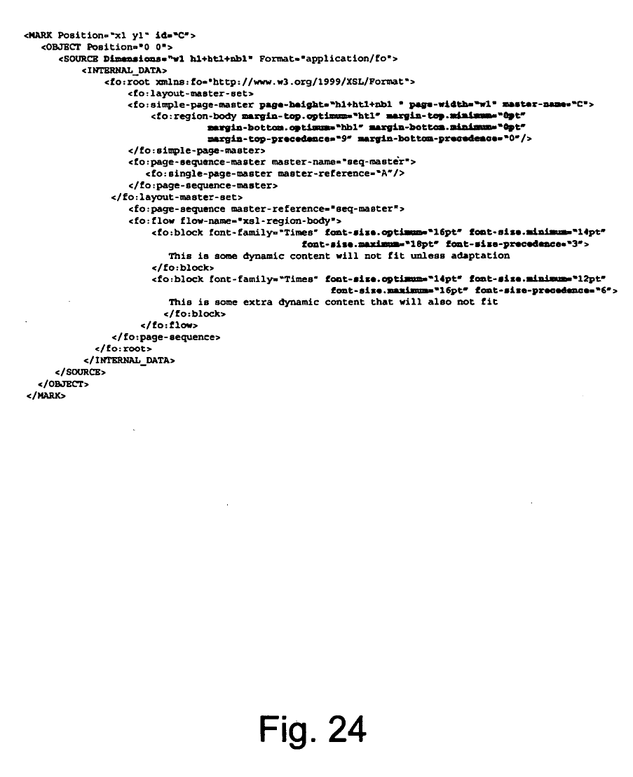

Referring to FIG. 24 herein, in order to show this concept, there is shown an example which merges the two approaches. In this case the graphic artist has defined how to enlarge the copy-hole bottom border and then re-size the fonts to fulfil the variable data. Only if these two operations are not successful will the copy-hole be enlarged on the top margin.

Using the precedence rules set by the graphic artist, the graphic artist can express the order of the operations and the XSL-FO Rendering Engine will behave as expected. The XSL-FO Rendering Engine also has a limited number of possible parameters to vary and when it will modify one this will became fixed.

In this way the algorithm is finite and will end in a pre-determined number of steps that could be, in the worst case, the number of changeable parameters for the number of possible values. Those parameters are directly settable from the graphic artist. The graphic artist, in fact, can select to adapt the document in a very refined way expressing a high number of parameters or choosing to express just a couple of those to accommodate all the variable data instances. This will depend by the document and application typology.

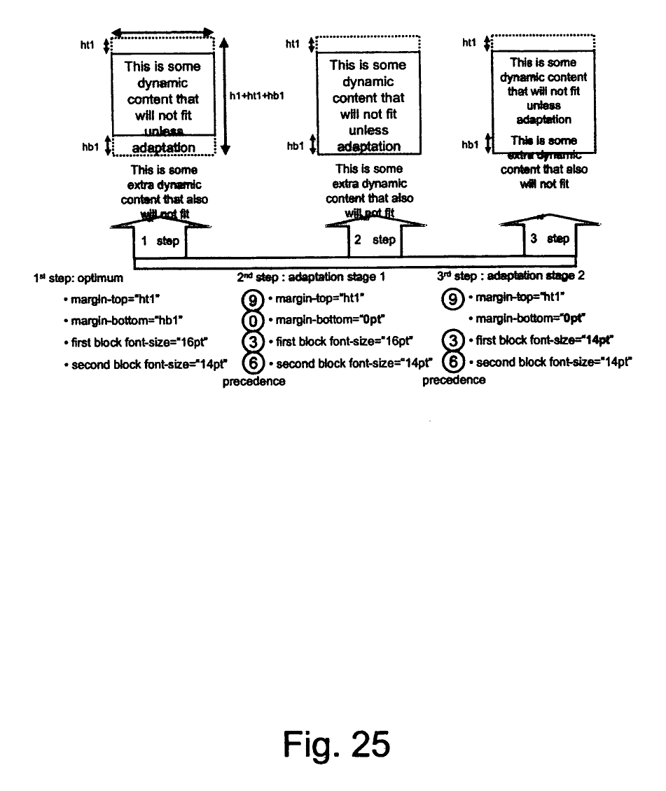

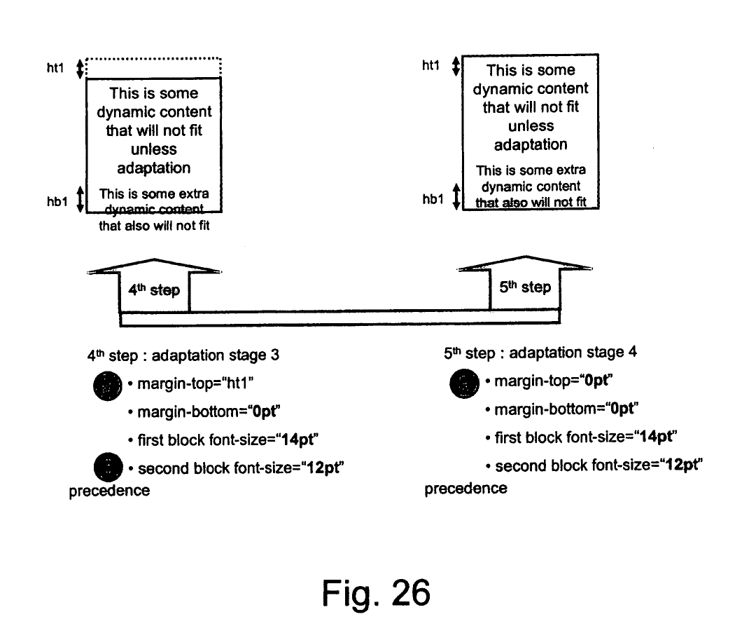

Referring to FIGS. 25 and 26 herein, there is shown schematically, the various steps executed by the XSL-FO Rendering Engine according to the above example.

At the beginning the XSL-FO Rendering Engine will try the optimum solution, which usually, will be applicable in most of the cases. If the variable data does not fit, the engine will apply the changes labelled with the lower precedence.

In XSL-FO there are already some attributes that have a precedence modifier and this usually express the importance of keeping it as originally set. In this approach a higher precedence identifies attributes that the graphic artist is willing to change as a last resort. In the shown example the margin-bottom has precedence=“0” and it will be collapsed to zero as first attempt. Since also this attempt fails, the engine will reduce the font-size for the first block that has, again, the lower precedence (three).

In the first steps shown in FIG. 25, there is dynamic content which will not 30 fit into the available space of the copy-hole unless some adaptation of the content is carried out. Further, there is some additional dynamic content which will also not fit into the available space in the copy-hole. The copy-hole is initially set with a top margin value, a bottom margin value, and font sizes for first and second blocks of text corresponding to the dynamic content, and the additional dynamic content. In this case, the dynamic content is set with a font size of 16 pt, and the additional dynamic content is set with a default font size of 14 pt.

In a second step shown in FIG. 25, corresponding to a first stage of content adaptation, the bottom margin is contracted to its minimum value, so as to enable more space for the content. In a third step corresponding to a second stage of adaptation, a font size of a first block of text is reduced from 16 pt to 14 pt, which allows the first block of dynamic content to fit within the copy-hole, but not the additional dynamic content.

In a fourth step, shown in FIG. 26, corresponding to a third stage of adaptation, a font size of the additional text block is reduced from 14 pt to 12 pt, allowing more of the additional content to fit into the copy-hole.

In a fifth step, corresponding to a fourth stage of adaptation, an upper margin is reduced from its default optimum size to its minimum size. The area available for the content now coincides with the maximum perimeter of the copy-hole, with the result that both the first block of text, at a reduced font size than originally envisaged, and the additional block of text, also at a reduced font size to its originally envisaged default font size both fit within the copy-hole.

In the above stages, an order of precedence in adaptation of the content items within an XSL-FO page is set to be as follows, firstly, the bottom margin is shrunk. Secondly, the first block font size is reduced. Thirdly, the second (additional) text block font size is reduced. fourthly, the upper margin dimension is reduced.

It will be appreciated by the person skilled in the art that a graphic artist may set any combination of precedents for shrinkage of font size, expansion/contraction of content image objects, expansion or contraction of upper, lower, left or right margins, which can be pre-set at the graphic artist authoring tool, for a particular document.

Referring to FIG. 26 herein, there is shown subsequent steps taken to achieve a final successful result.

Workflow Based on DTF, PPML/T, PPML and XSL-FO

These techniques can be developed using mostly available technologies. It will be necessary to create and support the necessary extensions but the XSL-FO and PPML combination has already proven several enhancements. Hewlett Packard company have defined the Document Template format (DTF) to better support the VDP Workflow through the PPML and PPML/T adoption. Using the embedded XSL-FO documents and the proposed extensions will be possible to enable the graphic artist authoring tools to better deal with the increasing problem of designing documents which contains variable and/or personalised content. FIG. 15 shows a block diagram for the proposed overall VDP workflow.

Specific embodiments according to the present invention include a rendering engine which is capable of implementing instructions contained in novel extension to the conventional XSL-FO language, for modifying dimensions of content, according to the XSL-FO extension instructions.

Specific embodiments and methods according to present invention may allow a graphic artist to control and/or have knowledge of operations provided by a system, for adapting the styling and/or layout of a document to accommodate the variable data.

The novel authoring and adaptation tools, disclosed herein, may provide a meaning to the graphic artist to accommodate the variable data inside the copy holes, providing some degree of flexibility which is under the graphics artist's control.

1. A method of processing a document comprising:
creating a plurality of copy holes in a PPML document; and
mapping said PPML copy holes into a plurality of pages of an XSL-FO document.

2. A method of printing data comprising a plurality of individual print items, said method comprising:
laying out at least one document page having at least one variable content copy hole;
abstracting a page description language copy hole into a document description language page;
fitting a variable content into a page;
rendering said page;
mapping said page to a copy hole formed in a page description language document; and
printing said rendered page within said variable content copy hole.

3. The method as claimed in claim 2, wherein said page comprises a page in extensible style sheet language formatting objects (XSL-FO).

4. The method as claimed in claim 2, wherein said copy holes are contained in pages of said PPML document; and
said pages of said PPML document are mapped to pages in said XSL-FO document.

5. A rendering command extension for extensible style sheet language, said rendering command comprising instructions to a rendering engine for modifying a content such that when said content is modified, it fits within a predetermined area.

6. The command as claimed in claim 5, said command comprising instructions for:
changing a text font size within predetermined limits.

7. The command as claimed in claim 5, comprising instructions for modifying a text line spacing.

8. The command as claimed in claim 5, comprising instructions for changing a magnification of an image.

9. The command as claimed in claim 5, said command comprising instructions for modifying a block layout of said content.

10. The command as claimed in claim 5, said command comprising instructions for modifying a margin of said content.

11. The command as claimed in claim 5, said command comprising instructions for modifying a border of said content.

12. A method of preparing content, said method comprising:
specifying a page within a document defined in a document description language;
assigning an item of content into said page; and
mapping said page to a copy hole formed in a page description language document.

13. The method as claimed in claim 12, wherein said document description language comprises extensible style sheet language formatting objects.

14. The method as claimed in claim 12, wherein said page description language comprises personalised printing mark-up language.

15. The method as claimed in claim 12, comprising:
rendering said content such that said content fits completely within said document description language page.

16. The method as claimed in claim 12, comprising:
providing a variable size margin on at least one side of said document description language page, between a border of said page and said content item.

17. The method as claimed in claim 12, comprising:
setting said content within a margin surrounding said content, within said document description language page.

18. The method as claimed in claim 12, further comprising:
setting said content within a margin, inside said document description language page, wherein said margin has:
a variable dimension upper margin;
a variable dimension left margin;
a variable dimension right margin; and
a variable dimension lower margin, wherein each of said upper, lower, left and right margins are independently variable.

19. The method as claimed in claim 12, comprising:
setting said content item and a margin within said document description language page, wherein said margin is variable between a minimum dimension of zero, and a pre-set maximum dimension, and with a default margin value being set at a pre-determined optimum value between said maximum and minimum values.

20. The method as claimed in claim 12, wherein said content item is positioned substantially centrally within said copy-hole.

21. A method of preparing content for inclusion in a copy-hole, said method comprising:
specifying a page within a document defined in a document description language; and
fitting an item of content into said page; and
mapping said page to a copy-hole formed in a page description language document.

22. A method of rendering a document comprising:
inputting a stream of document description language flow as objects;
arranging said objects in a page tree;
applying a sizing algorithm to said objects of said page tree for re-sizing said objects according to instructions contained in said document description language;
predicting whether said content will exceed a corresponding respective area assigned to said object, in a copy-hole defined in a page description language; and
if said prediction determined that said object will exceed said corresponding respective area in said page description language copy-hole, then re-sizing said content object such that when it is rendered, it will fit within said corresponding copy-hole.

23. The method as claimed in claim 22, wherein said re-sizing comprises expanding or collapsing a margin from a default optimum value, to an intermediate value between a minimum pre-set value of said margin and a maximum pre-set value of said margin.

24. The method as claimed in claim 22, wherein said re-sizing comprises expanding said object.

25. The method as claimed in claim 22, wherein said re-sizing comprises contracting the size of said object.

26. The method as claimed in claim 22, comprising:
re-sizing a plurality of said objects together, by a same sizing proportion.

27. A graphic authoring tool capable of generating a document description language document, wherein, within a page of said document description language document there is specified,
a content item assigned to said page; and
a variable dimension margin.

28. The graphic authoring tool as claimed in claim 27, capable of defining said margin within a pre-determined lowered dimension, and a pre-determined upper margin dimension.

29. The graphic authoring tool of claim 27, capable of defining an optimum value of said variable dimension margin.

30. A printing system for printing a plurality of individual print items, said printing system comprising:
a component capable of laying out at least one document page having at least one variable content copy hole;
a component capable of fitting a variable content into a page;
a rendering engine capable of rendering said page; and
a printing component capable of printing said rendered page within said variable content copy hole.

31. Program code stored on a data carrier, said program code comprising instructions for:
specifying a page within a document defined in a document description language;
fitting an item of content into said page; and
mapping said page to a copy-hole formed in a page description language document.

32. A rendering engine for rendering a document, said engine comprising:
a page tree for arranging a stream of document description language flow objects within a tree structure;
a sizing component capable of being applied to said objects of said page tree for re-sizing said objects according to instructions contained in said document description language;
a prediction component for predicting whether said content will exceed a corresponding respective area assigned to said object, in a copy-hole defined in a page description language; wherein
if said prediction component determines that said object will exceed said corresponding respective area in said page description language copy-hole, then said sizing component operates to re-size said content object such that when it is rendered, it will fit within said corresponding copy-hole.

33. A method of processing a document comprising:
creating a plurality of copy holes in a page description language document; and
mapping said copy holes into a plurality of pages of a document description language document.

34. A method of generating an output document for rasterizing into a bitmap, comprising the steps of:
designating, in a source document, a copy hole for accommodation of variable content;
rendering variable content intended to be located in the copy hole;
establishing, in accordance with predefined rules, whether the rendered variable content fits in the copy hole;
if not, adjusting a characteristic of the variable content and re-rendering the adjusted content.

35. A method according to claim 34 wherein the variable content is text and the adjusted characteristic is selected from the group comprising: font size, margin size, line spacing, text line height, text block spacing, text line width.

36. A method according to claim 34 wherein the variable content is an image and the adjusted characteristic is image magnification.

37. A method according to claim 35 wherein a plurality of characteristics of the variable content are adjusted to enable it to fit.

38. A method according to claim 37 wherein limits are set on the permissible extent of adjustment of the variable content.

39. A method according to claim 38 wherein if once the aforesaid limits are reached, the variable content does not fit,
